(19) United States
(12) Patent Application Publication
(10) Pub. No.: US 2023/0304624 A1
(43) Pub. Date: Sep. 28, 2023

(54) MULTI-SECTIONAL COMPOSITE CLAMPS

(71) Applicant: Saudi Arabian Oil Company, Dhahran (SA)

(72) Inventors: Abderrahim Fakiri, Dhahran (SA); Fadhel Alaithan, Al-Ahsa (SA); Md Anwar Parvez, Dhahran (SA)

(21) Appl. No.: 17/705,903

(22) Filed: Mar. 28, 2022

(51) Int. Cl. F16L 55/172; F16L 3/10

(52) U.S. Cl. CPC F16L 55/172; F16L 3/10

(57) ABSTRACT

Methods, apparatus, devices, and systems for clamping hollow structures with multi-sectional composite clamps are provided. In one aspect, a method includes: sequentially clamping at least two clamp layers around the hollow structure by clamping a first clamp layer around the hollow structure by connecting one or more clamp sections of the first clamp layer to form at least one first joint and clamping a second clamp layer around the first clamp layer by connecting one or more clamp sections of the second clamp layer to form at least one second joint. The at least one second joint and the at least one first joint mismatch with each other around the hollow structure.

### TECHNICAL FIELD

The present disclosure relates to clamp structures, particularly to clamps for repairing defected hollow structures such as pipelines.

### BACKGROUND

Large pipelines, for example metallic pipelines conducting hydrocarbon products, are often located in hostile environments such as off-shore structures. Pipelines may therefore be subjected to corrosion and/or damage from collisions or even deliberate attacks. Frequent replacement and/or repair of pipelines may therefore be necessary. Besides the expense of the replacement or repair, it may be necessary to shut down equipment to which the pipeline is connected while the replacement or repair is carried out. Some repair resolutions may be susceptible to corrosion, require welding, need hot work permit, add more weight and stress (e.g., for elevated structures), or be used as a temporary solution (e.g., when corrosion is active). Therefore, it is desirable for improved approaches of repairing pipelines to reduce repair costs, times, and complexity.

### SUMMARY

The present specification describes methods, apparatus, and systems for clamping hollow structures (e.g., tubular structures such as pipes) using multi-sectional composite clamps, e.g., for repairing defected areas in the hollow structures.

One aspect of the present disclosure features a method of clamping a hollow structure. The method includes: sequentially clamping at least two clamp layers around the hollow structure that includes clamping a first clamp layer around the hollow structure by connecting one or more clamp sections of the first clamp layer to form at least one first joint, and clamping a second clamp layer around the first clamp layer by connecting one or more clamp sections of the second clamp layer to form at least one second joint. The at least one second joint and the at least one first joint mismatch with each other around the hollow structure.

In some implementations, adjacent first joint of the at least first joint and second joint of the at least second joint are apart from each other around the hollow structure with an angle that is larger than 0 degree and no more than 180 degrees. In some examples, the at least first joint includes two first joints apart from each other around the hollow structure with a first angle of about 180 degrees, and the at least second joint includes two second joints apart from each other around the hollow structure with a second angle of about 180 degrees. In some examples, the angle between the adjacent first joint and second joint is about 90 degrees.

In some implementations, at least one of the at least two clamp layers includes a first clamp section and second clamp section.

In some implementations, the first clamp section includes two female ends, and the second clamp section includes two male ends. The method includes: connecting the first clamp section with the second clamp section by connecting the two female ends of the first clamp section respectively with the two male ends of the second clamp section to form two corresponding joints.

In some implementations, the first clamp section includes a first female end and a first male end, and the second clamp section includes a second female end and a second male end. The method includes: connecting the first clamp section with the second clamp section by connecting the first female end of the first clamp section to the second male end of the second clamp section to form a first corresponding joint, and connecting the first male end of the first clamp section to the second female end of the second clamp section to form a second corresponding joint.

In some implementations, the method includes: connecting the first clamp section with the second clamp section by connecting ends of the first clamp section and the second clamp section with a resilient seal member between the ends.

In some implementations, one or more clamp sections of at least one of the at least two clamp layers are connected by at least one of snap fitting, scarf-type jointing, stepped lap jointing, or insertion.

In some implementations, an inner surface of the first clamp layer has a substantially same shape as an outer surface of the hollow structure, and an inner surface of the second clamp layer has a substantially same shape as an outer surface of the first clamp layer.

In some implementations, the method includes: performing a surface treatment on one or more defected areas of the hollow structure, then clamping the first clamp layer around the one or more defected areas of the hollow structure.

In some implementations, the method further includes at least one of: before clamping the first clamp layer around the hollow structure, adding a first adhesive layer around an area where the first clamp layer is to be clamped around the hollow structure, or before clamping the second clamp layer around the first clamp layer, adding a second adhesive layer around the first clamp layer.

In some implementations, the method further include: fastening the at least two clamp layers on the hollow structure.

In some implementations, fastening the at least two clamp layers on the hollow structure includes: fastening one or more fastening clamps around the at least two clamp layers along a longitudinal direction of the hollow structure by one or more rods passing through the one or more fastening clamps along the longitudinal direction.

In some implementations, fastening the at least two clamp layers on the hollow structure includes: fastening a fastening clamp around the at least two clamp layers by fitting hinges on a first end of the clamp into grooves on a second end of the fastening clamp.

In some implementations, fastening the at least two clamp layers on the hollow structure includes: wrapping a wrap on the at least two clamp layers along a longitudinal direction of the hollow structure. Fastening the at least two clamp layers on the hollow structure can further include at least one of: adding an adhesive layer between an outer surface of and the wrap, or fastening a temporary clamp or strap on the wrap until a material of the wrap is cured, then removing the temporary clamp or strap.

In some implementations, at least one of the at least two clamp layers is made of a nonmetallic material.

In some implementations, at least one of the at least two clamp layers is made of a composite material including at least one of a thermoplastic material or a thermoset material reinforced with glass, carbon, basalt fibers, or aramid fibers.

Another aspect of the present disclosure features an apparatus for clamping a hollow structure. The apparatus includes at least two clamp layers having a first clamp layer and a second clamp layer. An inner surface of the first clamp layer has a substantially same first shape as an outer surface of the hollow structure, and an inner surface of the second clamp layer has a substantially same second shape as an outer surface of the first clamp layer. Each of the at least two clamp layers includes one or more clamp sections connectable to form at least one joint.

In some implementations, the apparatus further includes a fastening structure configured to fasten the at least two clamp layers on the hollow structure. The fastening structure includes at least one of: one or more fastening clamps configured to be fastened by one or more bolts passing through the one or more fastening clamps, a fastening clamp having hinges on a first end and grooves on a second end that are connectable to each other, or a wrap configured to be wrapped around the at least two clamp layers.

A further aspect of the present disclosure features a clamped hollow structure including: a hollow structure and at least two clamp layers sequentially around the hollow structure. Each of the at least two clamp layers is connected to form at least one joint, and two adjacent joints corresponding to two adjacent clamp layers mismatch with each other around the hollow structure.

In some implementations, the clamped hollow structure further includes: a fastening structure around an outer surface of the at least two clamp layers. The fastening structure includes: one or more fastening clamps fastened on the outer surface of the at least two clamp layers along a longitudinal direction by one or more bolts passing through the one or more fastening clamps along the longitudinal direction, a fastening clamp having hinges on a first end and grooves on a second end that are fitted with each other, or a wrap wound around the at least two clamp layers along the longitudinal direction.

The details of one or more implementations of the subject matter of this specification are set forth in the accompanying drawings and associated description. Other features, aspects, and advantages of the subject matter will become apparent from the description, the drawings, and the claims.

### DESCRIPTION OF DRAWINGS

FIG. 1 is a schematic diagram illustrating an example multi-sectional composite clamp, according to one or more embodiments of the present disclosure.

FIG. 2 is a schematic diagram illustrating an example structure including a pipe clamped by a multi-sectional composite clamp, according to one or more embodiments of the present disclosure.

FIG. 3 is a schematic diagram illustrating an example configuration of fibers for a multi-sectional composite clamp, according to one or more embodiments of the present disclosure.

FIGS. 4A-4B illustrate an example fastening configuration for fastening multi-sectional composite clamps on a pipe, according to one or more embodiments of the present disclosure.

FIGS. 5A-5B illustrate an example fastening configuration for fastening a multi-sectional composite clamp on a pipe, according to one or more embodiments of the present disclosure.

FIGS. 6A-6B illustrate another example fastening configuration for fastening a multi-sectional composite clamp on a pipe, according to one or more embodiments of the present disclosure.

FIG. 7 is a flowchart of an example process of clamping a hollow structure with a multi-sectional composite clamp, according to one or more embodiments of the present disclosure.

Like reference numbers and designations in the various drawings indicate like elements. It is also to be understood that the various exemplary implementations shown in the figures are merely illustrative representations and are not necessarily drawn to scale.

### DETAILED DESCRIPTION

### Overview

Implementations of the present disclosure provide methods, apparatus and techniques for clamping hollow structures (e.g., tubular structures such as pipes) with multi-sectional composite clamps, for example, by mismatching (or offsetting) joints of connected clamp sections of adjacent clamp layers to avoid or eliminate any potential leakage path formed through the mismatched joints. In the present disclosure, the term “mismatching” means: being apart from each other around a hollow structure (e.g., along a circumferential direction of a hollow structure), or having an angular offset relative to a central axis defined by the hollow structure (or along the circumferential direction of the hollow structure).

In some implementations, a multi-sectional composite clamp includes at least two clamp layers. Each clamp layer can include one or more clamp sections (e.g., two halves) that can be connected together, for example, by snap fitting, scarf-type jointing, inserting into one another as a female and male fitting, or any suitable connection manner. A resilient seal member (e.g., a rubber gasket) can be placed between ends of two clamp sections to provide a seal between two clamp sections and to allow compression during sequential fastening or tightening steps or operations.

The multi-sectional composite clamp can be used to clamp a hollow structure (e.g., a defected pipe). A first clamp layer (e.g., a first pair of clamp sections) can be firstly positioned (e.g., mounted) around the hollow structure, and the one or more clamp sections of the first clamp layer are connected together to form at least one first joint, e.g., two first joints apart from each other around the hollow structure. An inner surface of the connected clamp sections of the first clamp layer can have a substantially same (or exact) shape of an outer surface of the hollow structure, such that the connected clamp sections of the first clamp layer can be closely adhered with or attached to the hollow structure. In some implementations, before the first clamp layer is positioned on the hollow structure, a surface preparation of one or more defected areas of the hollow structure can be performed, e.g., by cleaning or abrading the one or more defected areas. In some cases, a filling material (or a filler) can be added onto a defected area and an adhesive layer can be placed to ensure good bonding and sealing between the first clamp layer of clamp sections and the hollow structure to eliminate any potential leakage.

After the first clamp layer is clamped on the hollow structure, a second clamp layer is positioned (e.g., mounted) around (or on top of) the first clamp layer, and one or more clamp sections of the second clamp layer can be connected together to form at least one second joint, e.g., two second joints apart from each other around the first clamp layer or the hollow structure. An inner surface of the connected clamp sections of the second clamp layer can have a substantially same or exact shape of an outer surface of the clamp sections of the first clamp layer, such that the connected clamp sections of the second clamp layer can be closely adhered with or attached to the connected clamp sections of the first clamp layer.

As noted above, clamp sections of the first clamp layer and/or the second clamp layer can be connected by snap fitting as a male and female connection or in any other manner such as a scarf-type point joint or inserting. End fittings (e.g., the at least one second joint) of the connected clamp sections of the second clamp layer can be offset or mismatched with end fittings (e.g., the at least one first joint) of the connected clamp sections of the first clamp layer, e.g., adjacent first joint and second joint can be 90 degrees apart from each other around the hollow structure. That is, the end fittings of the connected first clamp layer and the connected second clamp layer does not meet with each other, which can avoid overlaps between the end fittings to create a potential path for leakage and can make the end fittings to be less susceptible to leak.

In some implementations, an adhesive layer can be placed between the first clamp layer and the second clamp layer, e.g., after the first clamp layer is clamped on the hollow structure and before positioning the second clamp layer, which can increase adhesion between the connected clamp sections of the first clamp layer and the connected clamp sections of the second clamp layer to reduce or eliminate any leakage.

In some implementations, two or more clamp layers can be clamped (e.g., mounted and connected) around the hollow structure to eliminate any potential leakage. In some implementations, once the two or more layers of clamp sections are mounted and connected around the hollow structure, one or more fastening configurations can be put on an outer surface of the two or more clamp layers to fasten the two more clamp layers on the hollow structure.

The multi-sectional composite clamp can be a pressure containing nonmetallic clamp. In some implementations, the clamp sections of the first clamp layer and the second clamp layer can be made of one or more composite materials, e.g., thermoplastic or thermoset reinforced with glass, carbon, or basalt or aramid fibers. A material of the composite clamp can be chemically compatible with a fluid transported or carried in the hollow structure, can be resistant to a working temperature, and can be resistant to a working pressure. The material of the composite clamp can be determined based on one or more requirements in use.

The techniques can address existing challenges for repairing defected hollow structures. For examples, the techniques can efficiently and effectively repair the defected hollow structures to reduce or eliminate any potential leakage (e.g., oil and/or gas leakage) from the defected areas of the hollow structures. The techniques can reduce repair times and costs, without shutdown and hot work. The multi-sectional composite clamp can be corrosion resistant, easily manufactured and installed, inspectable as needed, and/or cost effective over pipeline lifecycles. The techniques can also be applied to any hollow structures that need to reduce or eliminate any potential leakage by clamping with one or more multi-sectional composite clamps.

A hollow structure can be a structure defining a cavity, e.g., for a fluidic substance such as oil or gas to flow, which can include a tubular structure such as a cylindrical structure, a rectangular channel structure, a caisson, a container, or any other suitable structure. A cross section of a hollow structure can have any suitable shape, e.g., a circular shape, a square or rectangular shape, an elliptical shape, or any suitable shape. For illustration purposes only, a pipe is used as an example of the hollow structure in the following descriptions. The pipe can be made of a metallic material or a plastic material.

A multi-sectional composite clamp can include two or more clamp layers that are configured to be sequentially (e.g., layer by layer) around a hollow structure. For illustration purposes only, two clamp layers are implemented as an example in the following instructions.

A clamp layer can include one or more clamp sections. Each clamp section can include two ends, e.g., a female end and a male end, two female ends, or two male ends. For illustration purposes only, in the following descriptions, each clamp layer includes a first clamp section (e.g., a female section) having two female ends and a second clamp section (e.g., a male section) having two male ends. The first clamp section and the second clamp section form a section pair.

Clamp sections of a clamp layer can be connected by any suitable connection manner, e.g., snap fitting, scarf-type jointing (such as single scarf jointing or double scarf jointing), inserting, stepped lap jointing (such as single stepped lap jointing or double stepped lap jointing), or any suitable female and male fitting. In a first example, for single scarf jointing, a first clamp section has a first wedge having a first sloped surface, and a second clamp section has a second wedge having a second sloped surface corresponding to the first sloped surface. The first clamp section and the second clamp section can be connected together by overlapping the first wedge and the second wedge such that the first sloped surface and the second sloped surface fit with each other. In a second example, for double scarf jointing, a first clamp section has a wedge having two sloped surfaces, and a second clamp section has a recess having two sloped surfaces corresponding to the sloped surfaces of the wedge. The first clamp section and the second clamp section can be connected together by inserting the wedge of the first clamp section into the recess of the second clamp section such that the two sloped surfaces of the wedge fit with the two sloped surfaces of the recess. In a third example, for a single stepped lap jointing, a first clamp section has a first wedge having first stepped surfaces, and a second clamp section has a second wedge having second stepped surfaces corresponding to the first stepped surfaces. The first clamp section and the second clamp section can be connected by overlapping the first wedge and the second wedge such that the first stepped surfaces and the second stepped surfaces fit with each other. In a fourth example, for a double stepped lap, a first clamp section has a wedge having two sides each having respective stepped surfaces, and a second clamp section has a recess having two sides each having respective stepped surfaces corresponding to the stepped surfaces of the wedge. The first clamp section and the second clamp section can be connected by inserting the wedge into the recess such that the stepped surfaces of the wedge fit with the stepped surfaces of the recess. For illustration purposes only, snap fitting is used as an example of the connection manner in the following descriptions.

### Example Multi-Sectional Composite Clamps

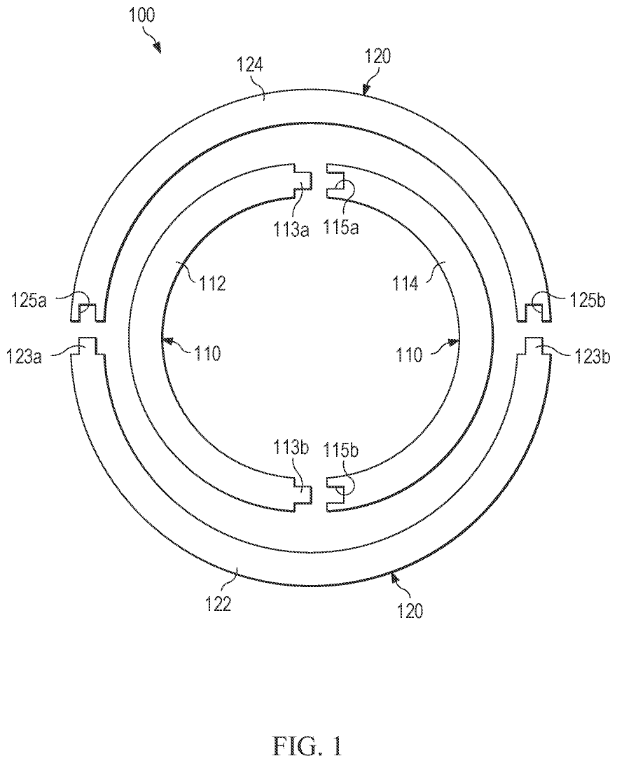

FIG. 1 is a schematic diagram illustrating an example multi-sectional composite clamp 100, according to one or more embodiments of the present disclosure. The clamp 100 is configured to clamp a pipe. The clamp 100 includes two clamp layers: first clamp layer 110 and second clamp layer 120.

As illustrated in FIG. 1, the first clamp layer 110 includes a first clamp section 112 and a second clamp section 114. The first clamp section 112 includes two male ends 113a, 113b, and can be also considered as a first male clamp section. The second clamp section 114 includes two female ends 115a, 115b and can be also considered as a first female clamp section. The first clamp section 112 and the second clamp section 114 can be two semi-cylindrical halves. Similarly, the second clamp layer 120 includes a first clamp section 122 and a second clamp section 124. The first clamp section 122 includes two male ends 123a, 123b, and can be also considered as a second male clamp section. The second clamp section 124 includes two female ends 125a, 125b and can be also considered as a second female clamp section. The first clamp section 122 and the second clamp section 124 can be two semi-cylindrical halves.

Each male end, e.g., 113a, 113b, 123a, 123b, can be configured to be snap fitted with a respective female end, e.g., 115a, 115b, 125a, 125b. For example, as illustrated in FIG. 1, the male end 113a, 113b, 123a, 123b has a protrusion that can be fit into a recess of the respective female end 115a, 115b, 125a, 125b. The protrusion of the male end 113a, 113b, 123a, 123b has a smaller cross section than that of the first clamp section 112, 122, and the recess of the female end 115a, 115b, 125a, 125b has a smaller cross section than that of the second clamp section 114, 124. In such a way, after the male ends 113a, 113b are connected with (e.g., fitted into) the female ends 115a, 115b, there is no protrusion on an inner surface and an outer surface of the first clamp layer 110 to ensure a close fit with the pipe and the second clamp layer 120. After the male ends 123a, 123b are connected with (e.g., fitted into) the female ends 125a, 125b, there is no protrusion on an inner surface and an outer surface of the second clamp layer 120 to ensure a close fit with the first clamp layer 110 and a further fastening structure, e.g., a fastening clamp or wrap as described with further details below.

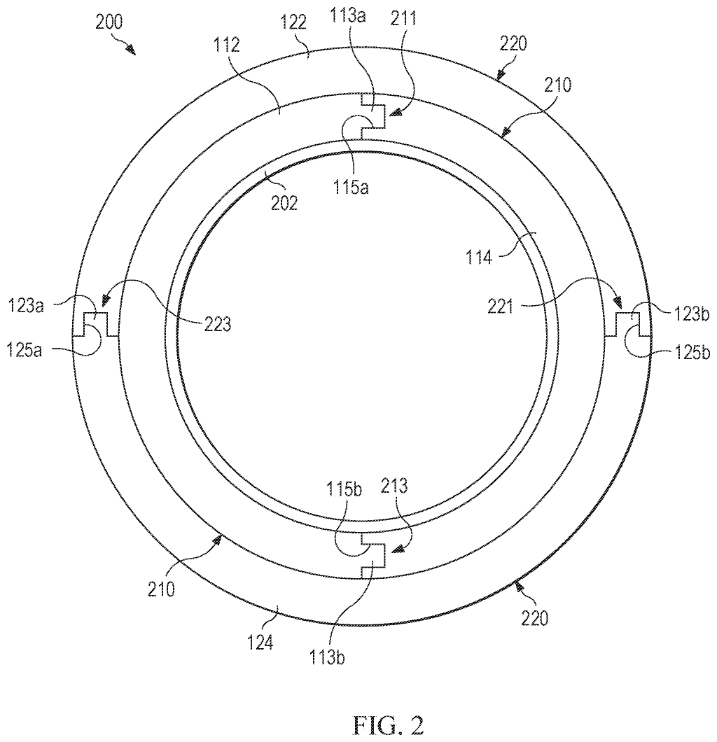

FIG. 2 is a schematic diagram illustrating an example structure 200 including a pipe 202 clamped by a multi-sectional composite clamp, according to one or more embodiments of the present disclosure. The multi-sectional composite clamp can be the clamp 100 of FIG. 1. The pipe 202 can be any carrier pipe or pipeline such as a flowline, a testline, a truckline, a disposal line, or a water supply line. The pipe 202 can include one or more defected areas. The structure 200 can be a repaired pipe with the multi-sectional composite clamp clamped around one or more defected areas.

As illustrated in FIG. 2, the structure 200 includes a first clamp layer 210 and a second clamp layer 220. The first clamp layer 210 can be the first clamp layer 110 of FIG. 1 with the male ends 113a, 113b connected with the female ends 115a, 115b to form two first joints 211, 213. The second clamp layer 220 can be the second clamp layer 120 of FIG. 1 with the male ends 123a, 123b connected with the female ends 125a, 125b to form two second joints 221, 223. An inner surface of the first clamp layer 210 can have a substantially same shape (and size) as an outer surface of the pipe 202, such that the first clamp layer 210 can be closely clamped on the pipe 202. An inner surface of the second clamp layer 220 can have a substantially same shape (and size) and an outer surface of the first clamp layer 210, such that the second clamp layer 220 can be closely clamped on the first clamp layer 210.

The pipe 202 can extend along a longitudinal direction that is perpendicular to an axial direction. A length of the first clamp layer 210 along the longitudinal direction can be at least greater than a length of one or more defect areas of the pipe 202. A length of the second clamp layer 220 along the longitudinal direction can be no less than the length of the first clamp player 210. In some implementations, a plurality of multi-sectional composite clamps can be clamped around the pipe 202 at a series of discrete locations (e.g., defected areas) along the longitudinal direction.

In some examples, the first clamp layer 210 or the second clamp layer 220 has a length in a range of from 0.5 meter to 10 meters. In some examples, the first clamp layer 210 or the second clamp layer 220 has a thickness in a range of from 0.5 mm to 20 mm. In some examples, an inner surface of the first clamp layer 210 has a diameter in a range of from 5 mm to 200 mm.

The first clamp layer 210 includes two first joints 211, 213. The first clamp section 112 and the second clamp section 114 can be two halves, and the two first joints 211, 213 are apart from each other with an angle of about 180 degrees around the pipe 202, e.g., along a circumferential direction of the pipe 202. Similarly, two second joints 221, 223 of the second clamp layer 220 are apart from each other with an angle of about 180 degrees around the first clamp layer 210 or the pipe 202, e.g., along the circumferential direction of the pipe 202.

To avoid any potential leakage from a defect area of the pipe 202 and/or the joints 211, 213, 221, 223, adjacent first joint and second joint, e.g., 211 and 221 or 223, 213 and 221 or 223, of the adjacent first clamp layer 210 and second clamp layer 220 mismatch with each other, e.g., be offset or apart from each other, around the pipe 202. That is, the adjacent first joint and second joint do not overlap with each other. In some examples, as illustrated in FIG. 2, the adjacent first joint and second joint are apart from each other with an angle of 90 degrees around the pipe 202. In such a way, a potential leakage from a defected area of the pipe 202 can be prevented from the first joint 211 or 213 of the first clamp layer 210 to leak from the second joint 221, 223 of the second clamp layer 220.

In some implementations, a resilient seal member (e.g., a rubber gasket) is placed between a male end and a female end of two clamp sections, e.g., 113a and 115a, 113b and 115b, 123a and 125a, or 123b and 125b, which can provide a seal and allow compression during tightening.

In some implementations, before the first clamp layer 210 is clamped on the pipe 202, a surface preparation of one or more defected areas of the pipe 202 can be performed, e.g., by cleaning or abrading the one or more defected areas. In some cases, a filling material (or a filler) can be added onto a defected area (e.g., due to external corrosion) and an adhesive material or layer can be placed to ensure good bonding and sealing between the first clamp layer 210 and the pipe 202 to eliminate any potential leakage.

In some implementations, an adhesive layer can be placed between the first clamp layer 210 and the second clamp layer 220, e.g., after the first clamp layer 210 is clamped on the pipe 202 and before clamping the second clamp layer 220, which can increase adhesion between the first clamp layer 210 and the second clamp layer 220 to reduce or eliminate any leakage.

The multi-sectional composite clamp can be a pressure containing nonmetallic clamp. In some implementations, a clamp section 112, 114, 122, 124 of the first clamp layer 210 and the second clamp layer 220 can be made of a nonmetallic material or a composite material, e.g., thermoplastic or thermoset reinforced with glass, carbon, or basalt or aramid fibers.

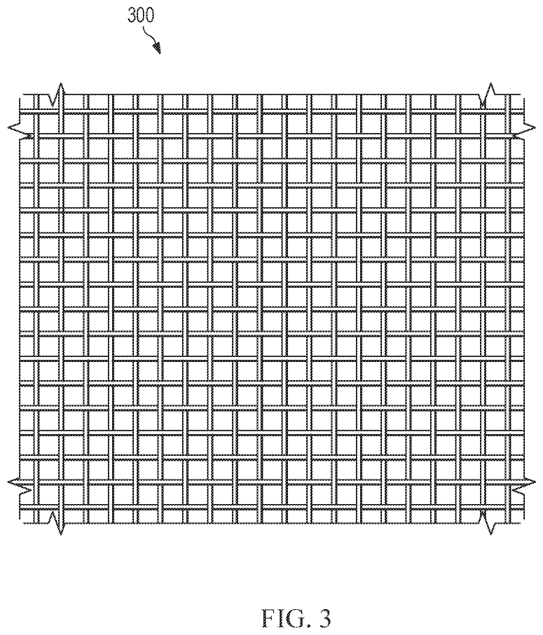

The clamp section 112, 114, 122, 124 can be made of cross-ply laminate or woven stack in multiple layers to have a section thickness that can be predetermined, e.g., for repairing. The fibers in the laminate can be oriented in 0° or 90° direction to provide an axial strength and a hoop strength, respectively, as illustrated in FIG. 3.

In some implementations, for a thermoplastic composite, plies can be made with fibers wetted with thermoplastic resins. The plies can be stacked together and molded using compression press to make a clamp section (e.g., a semi-cylindrical section). Ends of the clamp section can be machined to make two female ends, two male ends or a female end and a male end.

In some implementations, for a thermoset composite, resin transfer molding (RTM) or vacuum bagging can be used to mold a clamp section (e.g., a semi-cylindrical section) using dry fiber lay-up and thermosetting resins, such as polyester, or vinyl ester or epoxy.

### Example Fastening Configurations

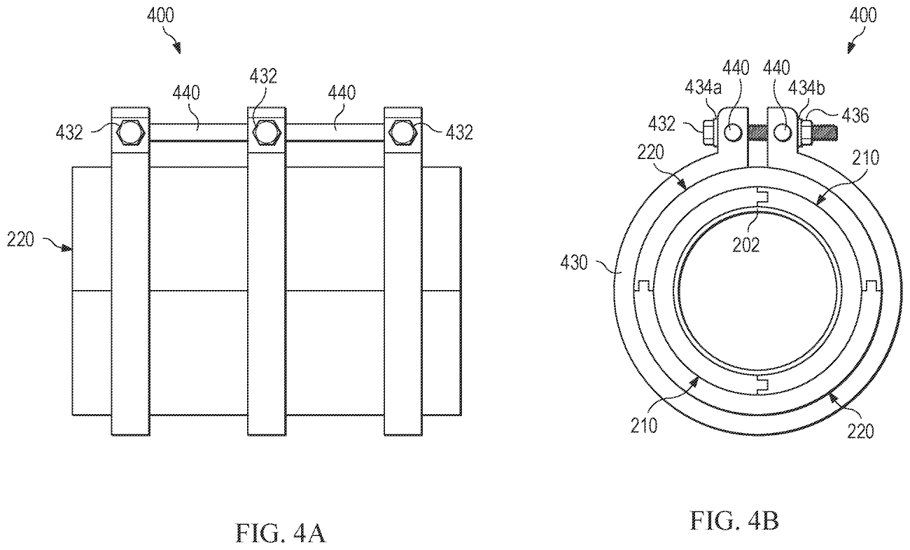

Once two or more clamp layers are sequentially clamped (e.g., mounted) onto a pipe, the two or more clamp layers can be further fastened by a fastening configuration, as illustrated in FIG. 4A-4B, 5A-5B, or 6A-6B.

FIGS. 4A-4B illustrate an example fastening configuration 400 for fastening multi-sectional composite clamps on a pipe, according to one or more embodiments of the present disclosure. The pipe can be the pipe 202 of FIG. 2 and extend along a longitudinal direction. A series of multi-sectional composite clamps can be clamped on the pipe 202 and spaced from one another along the longitudinal direction.

Each multi-sectional composite clamp can be the clamp 100 of FIG. 1, and can include first clamp layer 210 (e.g., a first section pair including a first female section and a first male section) and a second clamp layer 220 (e.g., a second section pair including a second female section and a second male section). The first clamp layer 210 and the second clamp layer 120 can be sequentially clamped onto the pipe 202 to form a structure similar to the structure 200 of FIG. 2.

As illustrated in FIGS. 4A-4B, the fastening configuration 400 includes three fastening clamps 430 connected by two rods 440 that pass through the fastening clamps 430. Each fastening clamp 430 can be fastened by a bolt 432 and a nut 436. The nut 436 can be tightened by applying a predetermined amount of load for compression, e.g., beyond a required amount of load. The fastening clamp 430 can be made of a metallic material or a composite material with high modulus of elasticity, e.g., carbon/glass fiber and epoxy matrix to resist compression during a tightening process for the nut 436. In some implementations, washers 434a, 434b can be added respectively between the bolt 432 and the fastening clamp 430 and between the fastening clamp 430 and the nut 436.

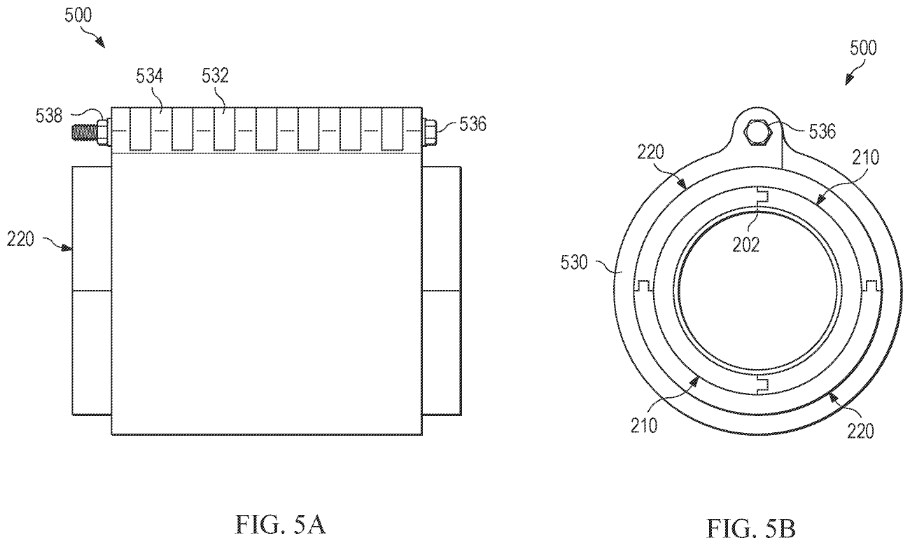

FIGS. 5A-5B illustrate an example fastening configuration 500 for fastening a multi-sectional composite clamp on a pipe, according to one or more embodiments of the present disclosure. The pipe can be the pipe 202 of FIG. 2 and extend along a longitudinal direction. The multi-sectional composite clamp can be the clamp 100 of FIG. 1, and can include a first clamp layer 210 and a second clamp layer 220 that can be sequentially clamped onto the pipe 202 to form a structure similar to the structure 200 of FIG. 2.

As illustrated in FIGS. 5A-5B, the fastening clamp (or sleeve) 530 has hinges 532 on one side and grooves 534 on the other side. The hinges 532 and the grooves 534 can fit into one another to form a connection. A bolt 536 can be placed inside the hinges and extended beyond a length of the fastening clamp 530. An extended part of the bolt 536 can be threaded where a nut 538 (and optionally one or more washers such as 434a, 434b of FIG. 4B) can be placed for fastening by the nut 538 to a predetermined load (e.g., no less than a required load) for the fastening clamp 530 to be firmly tightened on the clamp layers 210, 220 and the pipe 202. In some implementations, a resilient seal member (e.g., a rubber gasket) can be inserted inside of the hinges 532 to provide a seal and compression.

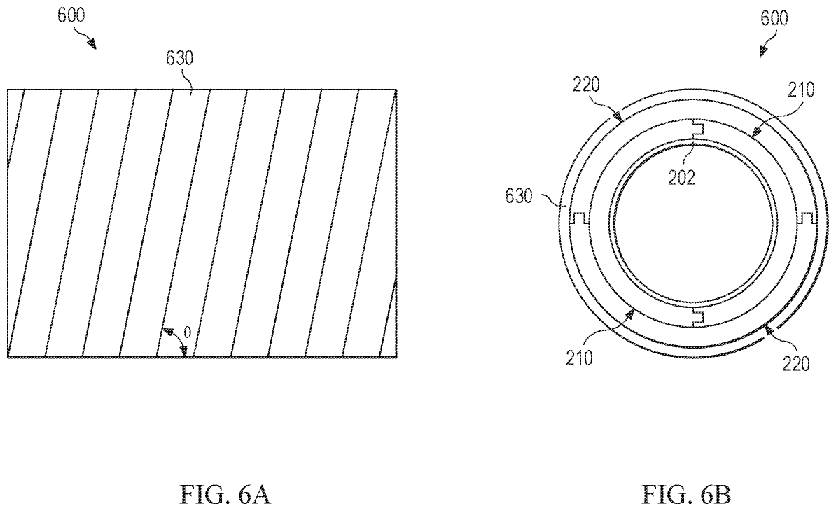

FIGS. 6A-6B illustrate another example fastening configuration 600 for fastening a multi-sectional composite clamp on a pipe, according to one or more embodiments of the present disclosure. The pipe can be the pipe 202 of FIG. 2 and extend along a longitudinal direction. The multi-sectional composite clamp can be the clamp 100 of FIG. 1, and can include a first clamp layer 210 and a second clamp layer 220 that can be sequentially clamped onto the pipe 202 to form a structure similar to the structure 200 of FIG. 2.

The fastening configuration 600 includes a wrap 630 that can be firmly tightened on an outer surface of the clamp layers 210, 220. The wrap 630 can be made of a composite material, e.g., a composite tape or fabric, or a composite material of the clamp layers 210, 220. The wrap 630 can be wound on the clamp layer 220 with a predetermined angle θ, e.g., 55°, to provide a balanced hoop and longitudinal strength.

In some implementations, an adhesive layer is added between the second clamp layer 220 and the wrap 630. In some implementations, a temporary clamp or strap is placed and tightly fastened on the wrap 630 until a material of the wrap 630 is cured (e.g., fully cured such that the material is fully crosslinked to reach a certain rigidity and strength), and then the temporary clamp or strap can be removed. The material of the wrap 630 can be a thermoset material, e.g., the composite material used for a clamp layer.

### Example Processes

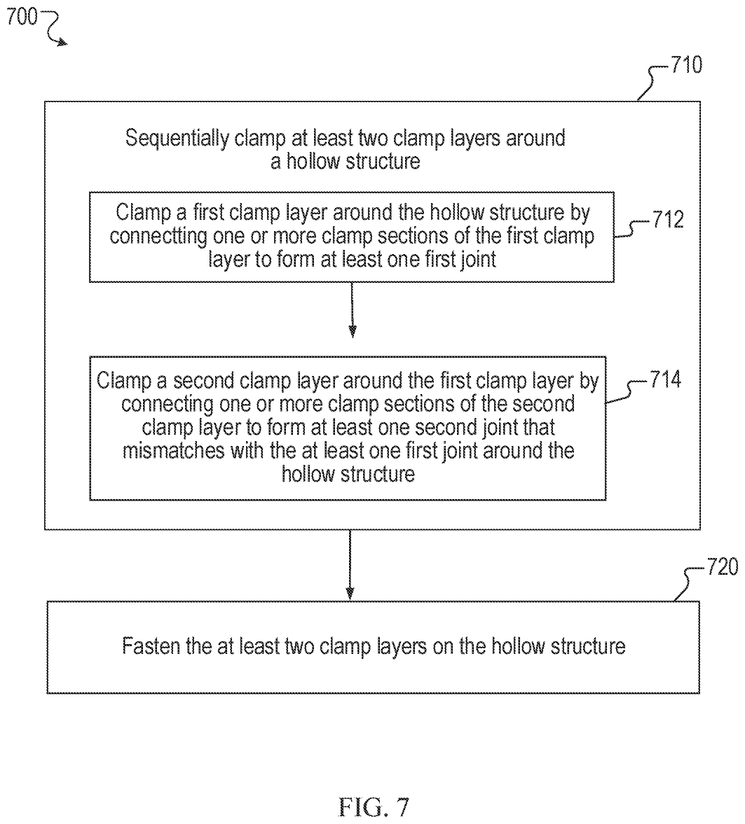

FIG. 7 is a flowchart of an example process 700 of clamping a hollow structure with a multi-sectional composite clamp, according to one or more embodiments of the present disclosure. The hollow structure can be a pipe, e.g., the pipe 202 of FIG. 2. The multi-sectional composite clamp can be the clamp 100 of FIG. 1. The multi-sectional composite clamp can include at least two clamp layers.

The at least two clamp layers are sequentially clamped around the hollow structure (710), including: clamping a first clamp layer around the hollow structure by connecting one or more clamp sections of the first clamp layer to form at least one first joint (712), and clamping a second clamp layer around the first clamp layer by connecting one or more clamp sections of the second clamp layer to form at least one second joint (714). The at least one second joint and the at least one first joint mismatch with each other around the hollow structure. In some implementations, one or more clamp layers can be further sequentially clamped around the second clamp layer.

Clamping the first clamp layer around the hollow structure can include: positioning the one or more clamp sections of the first clamp layer around the hollow structure and then connecting the one or more clamp sections of the first clamp layer to form the at least one first joint, such that the one or more clamp sections of the first clamp layer are clamped or mounted on the hollow structure. Clamping the second clamp layer around the hollow structure can include: positioning the one or more clamp sections of the second clamp layer around the first clamp layer and then connecting the one or more clamp sections of the second clamp layer to form the at least one second joint, such that the one or more clamp sections of the second clamp layer are clamped or mounted on the first clamp layer. The one or more clamp sections of the second clamp layer can be positioned around the first clamp layer such that the at least one second joint to be formed mismatches (or is offset) with the at least one first joint formed in the first clamp layer.

The first clamp layer can be the first clamp layer 110 of FIG. 1 and can include a first clamp section, e.g., 112 of FIGS. 1-2, and a second clamp section, e.g., 114 of FIGS. 1-2. The second clamp layer can be the second clamp layer 120 of FIG. 1, and can include a first clamp section, e.g., 122 of FIGS. 1-2, and a second clamp section, e.g., 124 of FIGS. 1-2. In some implementations, one or more clamp sections of at least one of the at least two clamp layers are connected by at least one of snap fitting (e.g., as illustrated in FIGS. 1-2), scarf-type jointing, insertion, or any male-female fitting.

In some implementations, for at least one of the at least two clamp layers, e.g., the first clamp layer and/or the second clamp layer, the first clamp section includes two female ends, and the second clamp section includes two male ends. The first clamp section and the second clamp section can be connected by connecting the two female ends of the first clamp section respectively with the two male ends of the second clamp section to form two corresponding joints, e.g., the first joints 211, 213 or the second joints 221, 223 of FIG. 2.

In some implementations, for at least one of the at least two clamp layers, e.g., the first clamp layer and/or the second clamp layer, the first clamp section includes a first female end and a first male end, and the second clamp section includes a second female end and a second male end. The first clamp section and the second clamp section can be connected by connecting the first female end of the first clamp section to the second male end of the second clamp section to form a corresponding first joint, and connecting the first male end of the first clamp section to the second female end of the second clamp section to form a corresponding second joint.

In some implementations, for at least one of the at least two clamp layers, e.g., the first clamp layer and/or the second clamp layer, the first clamp section and the second clamp section can be connected by connecting ends of the first clamp section and the second clamp section with a resilient seal member between the ends. The resilient seal member can be a rubber gasket.

In some implementations, adjacent first joint of the at least first joint and second joint of the at least second joint, e.g., the first joint 211 and the second joint 221 or 223 of FIG. 2, or the first joint 213 and the second joint 221 or 223 of FIG. 2, are apart from each other around the hollow structure with an angle. The angle can be larger than 0 degree and no more than 180 degrees, e.g., 30 degrees, 45 degrees, 60 degrees, 75 degrees, 90 degrees, 105 degrees, 120 degrees, 135 degrees, 150 degrees, or 180 degrees. In some examples, the angle between the adjacent first joint and second joint is about 90 degrees. In some examples, the at least first joint includes two first joints (e.g., 211 and 213 of FIG. 2) apart from each other around the hollow structure with a first angle of about 180 degrees, and the at least second joint includes two second joints (e.g., 221 and 223 of FIG. 2) apart from each other around the hollow structure with a second angle of about 180 degrees. In some examples, the at least first joint includes three first joints apart from one another around the hollow structure with an angle of 120 degrees, and the at least second joint includes three second joints apart from one another around the hollow structure with an angle of 120 degrees, and adjacent first joint and second joint can be apart from each other around the hollow structure with an angle of 60 degrees.

In some implementations, after the one or more clamp sections of the first clamp layer are connected together, an inner surface of the first clamp layer (e.g., the first clamp layer 210 of FIG. 2) has a substantially same shape (and size) as an outer surface of the hollow structure. After the one or more clamp sections of the second clamp layer are connected together, an inner surface of the second clamp layer (e.g., the second clamp layer 220 of FIG. 2) has a substantially same shape as an outer surface of the first clamp layer.

In some implementations, the process 700 includes: performing a surface treatment on one or more defected areas of the hollow structure, and then clamping the first clamp layer around the one or more defected areas of the hollow structure.

In some implementations, the process 700 can further include at least one of: before clamping the first clamp layer around the hollow structure, adding a first adhesive layer around an area where the first clamp layer is to be clamped around the hollow structure, or before clamping the second clamp layer around the first clamp layer, adding a second adhesive layer around the first clamp layer.

After the at least two clamp layers are sequentially around the hollow structure, the at least two clamp layers are fastened on the hollow structure (720).

In some implementations, as illustrated in FIGS. 4A-4B, one or more fastening clamps (e.g., 430) are fastened around the at least two clamp layers along a longitudinal direction of the hollow structure by one or more rods (e.g., 440) passing through the one or more fastening clamps. The one or more fastening clamps can be fastened by bolts (e.g., 432) and nuts (e.g., 436). One or more washers (e.g., 434a, 434b) can also be added adjacent to the bolts and nuts for fastening.

In some implementations, as illustrated in FIGS. 5A-5B, a fastening clamp (e.g., 530) is fastened around the at least two clamp layers by fitting hinges (e.g., 532) on a first end of the fastening clamp into grooves (e.g., 534) on a second end of the fastening clamp. The fastening clamp can be fastened by a bolt (e.g., 536) and a nut (e.g., 538).

In some implementations, as illustrated in FIGS. 6A-6B, the at least two clamp layers are fastened on the hollow structure by wrapping a wrap (e.g., 630) on the at least two clamp layers along the longitudinal direction. The wrap can be a composite wrap, e.g., a composite tape or fabric. The wrap can be wound on the at least two clamp layers with a predetermined angle θ, e.g., 55°, to provide a balanced hoop and longitudinal strength. In some examples, an adhesive layer can be added between an outer surface of and the wrap. In some examples, a temporary clamp or strap is fastened on the wrap until a material of the wrap is cured, then the temporary clamp or strap is removed.

In some implementations, at least one clamp section of the at least two clamp layers is made of a nonmetallic material or a composite material. The composite material can include at least one of a thermoplastic material or a thermoset material reinforced with glass, carbon, basalt fibers, or aramid fibers.

Accordingly, the earlier provided description of example implementations does not define or constrain this specification. Other changes, substitutions, and alterations are also possible without departing from the spirit and scope of this specification.

What is claimed is:

1. A method of clamping a hollow structure, the method comprising:
sequentially clamping at least two clamp layers around the hollow structure comprising:
clamping a first clamp layer around the hollow structure by connecting one or more clamp sections of the first clamp layer to form at least one first joint; and
clamping a second clamp layer around the first clamp layer by connecting one or more clamp sections of the second clamp layer to form at least one second joint,
wherein the at least one second joint and the at least one first joint mismatch with each other around the hollow structure.

2. The method of claim 1, wherein adjacent first joint of the at least first joint and second joint of the at least second joint are apart from each other around the hollow structure with an angle that is larger than 0 degree and no more than 180 degrees.

3. The method of claim 2, wherein the at least first joint comprises two first joints apart from each other around the hollow structure with a first angle of about 180 degrees, and the at least second joint comprises two second joints apart from each other around the hollow structure with a second angle of about 180 degrees, and
wherein the angle between the adjacent first joint and second joint is about 90 degrees.

4. The method of claim 1, wherein at least one of the at least two clamp layers comprises a first clamp section and second clamp section.

5. The method of claim 4, wherein the first clamp section comprises two female ends, and the second clamp section comprises two male ends, and
wherein the method comprises:
connecting the first clamp section with the second clamp section by connecting the two female ends of the first clamp section respectively with the two male ends of the second clamp section to form two corresponding joints.

6. The method of claim 4, wherein the first clamp section comprises a first female end and a first male end, and the second clamp section comprises a second female end and a second male end, and
wherein the method comprises:
connecting the first clamp section with the second clamp section by connecting the first female end of the first clamp section to the second male end of the second clamp section to form a first corresponding joint, and connecting the first male end of the first clamp section to the second female end of the second clamp section to form a second corresponding joint.

7. The method of claim 4, comprising:
connecting the first clamp section with the second clamp section by connecting ends of the first clamp section and the second clamp section with a resilient seal member between the ends.

8. The method of claim 1, wherein one or more clamp sections of at least one of the at least two clamp layers are connected by at least one of
snap fitting,
scarf-type jointing,
stepped lap jointing, or
insertion.

9. The method of claim 1, wherein an inner surface of the first clamp layer has a substantially same shape as an outer surface of the hollow structure, and
wherein an inner surface of the second clamp layer has a substantially same shape as an outer surface of the first clamp layer.

10. The method of claim 1, comprising:
performing a surface treatment on one or more defected areas of the hollow structure; then
clamping the first clamp layer around the one or more defected areas of the hollow structure.

11. The method of claim 1, further comprising at least one of:
before clamping the first clamp layer around the hollow structure, adding a first adhesive layer around an area where the first clamp layer is to be clamped around the hollow structure, or
before clamping the second clamp layer around the first clamp layer, adding a second adhesive layer around the first clamp layer.

12. The method of claim 1, further comprising:
fastening the at least two clamp layers on the hollow structure.

13. The method of claim 12, wherein fastening the at least two clamp layers on the hollow structure comprises:
fastening one or more fastening clamps around the at least two clamp layers along a longitudinal direction of the hollow structure by one or more rods passing through the one or more fastening clamps along the longitudinal direction.

14. The method of claim 12, wherein fastening the at least two clamp layers on the hollow structure comprises:
fastening a fastening clamp around the at least two clamp layers by fitting hinges on a first end of the clamp into grooves on a second end of the fastening clamp.

15. The method of claim 12, wherein fastening the at least two clamp layers on the hollow structure comprises:
wrapping a wrap on the at least two clamp layers along a longitudinal direction of the hollow structure.

16. The method of claim 15, wherein fastening the at least two clamp layers on the hollow structure comprises at least one of:
adding an adhesive layer between an outer surface of the at least two clamp layers and the wrap, or
fastening a temporary clamp or strap on the wrap until a material of the wrap is cured, then removing the temporary clamp or strap.

17. The method of claim 1, wherein at least one of the at least two clamp layers is made of a nonmetallic material.

18. The method of claim 1, wherein at least one of the at least two clamp layers is made of a composite material comprising at least one of
a thermoplastic material or
a thermoset material reinforced with glass, carbon, basalt fibers, or aramid fibers.

19. An apparatus for clamping a hollow structure, the apparatus comprising:
at least two clamp layers comprising:
a first clamp layer; and
a second clamp layer,
wherein an inner surface of the first clamp layer has a substantially same first shape as an outer surface of the hollow structure, and an inner surface of the second clamp layer has a substantially same second shape as an outer surface of the first clamp layer,
wherein each of the at least two clamp layers comprises one or more clamp sections connectable to form at least one joint.

20. The apparatus of claim 19, further comprising:
a fastening structure configured to fasten the at least two clamp layers on the hollow structure, wherein the fastening structure comprises at least one of:
one or more fastening clamps configured to be fastened by one or more bolts passing through the one or more fastening clamps,
a fastening clamp having hinges on a first end and grooves on a second end that are connectable to each other, or
a wrap configured to be wrapped around the at least two clamp layers.

21. A clamped hollow structure comprising:
a hollow structure; and
at least two clamp layers sequentially around the hollow structure;
wherein each of the at least two clamp layers is connected to form at least one joint, and
wherein two adjacent joints corresponding to two adjacent clamp layers mismatch with each other around the hollow structure.

22. The clamped hollow structure of claim 21, further comprising:
a fastening structure around an outer surface of the at least two clamp layers, wherein the fastening structure comprises:
one or more fastening clamps fastened on the outer surface of the at least two clamp layers along a longitudinal direction by one or more bolts passing through the one or more fastening clamps along the longitudinal direction,
a fastening clamp having hinges on a first end and grooves on a second end that are fitted with each other, or
a wrap wound around the at least two clamp layers along the longitudinal direction.
